(19) United States
(12) Patent Application Publication
(10) Pub. No.: US 2015/0002239 A1
(43) Pub. Date: Jan. 1, 2015

(54) DIRECTIONAL COUPLER

(71) Applicant: Murata Manufacturing Co., Ltd., Kyoto-fu (JP)

(72) Inventor: Akira TANAKA, Kyoto-fu (JP)

(73) Assignee: Murata Manufacturing Co., Ltd., Kyoto-fu (JP)

(21) Appl. No.: 14/251,875

(22) Filed: Apr. 14, 2014

(30) Foreign Application Priority Data
Jun. 26, 2013 (JP) 2013-133989

(51) Int. Cl. H01P 5/18

(52) U.S. Cl. CPC H01P 5/184
USPC 333/116

(57) ABSTRACT

A directional coupler for use in a predetermined frequency band includes a laminate body including a laminate of a plurality of insulation layers, a first terminal through a fourth terminal disposed on a surface of the laminate body, a main line connected between the first terminal and the second terminal and disposed on the insulation layer, a first sub-line connected to the third terminal, electromagnetically coupled with the main line, and disposed on the insulation layer, a second sub-line connected to the fourth terminal, electromagnetically coupled with the main line, and disposed on the second sub-line, and a phase adjusting circuit connected between the first sub-line and the second sub-line and configured to cause a phase shift on a passing signal. The main line, the first sub-line and the second sub-line do not overlap each other in a plan view from a direction of lamination.

### BACKGROUND OF THE INVENTION

1. Field of the Invention

The present invention relates to directional couplers and more specifically to a directional coupler for use in a radio communication apparatus that performs communications using a high-frequency signal.

2. Description of the Related Art

A directional coupler described in Japanese Unexamined Patent Application Publication No. 2013-5076 is available as a related art direction coupler. The directional coupler includes a main line and a sub-line, opposed to each other with an insulation layer interposed therebetween. In this way, the main line and the sub-line are electromagnetically coupled with each other while being also capacitively coupled with each other.

A disadvantage with the directional coupler described in Japanese Unexamined Patent Application Publication No. 2013-5076 is an insufficient directivity. The flow of a signal in an electromagnetic coupled state and a capacitively coupled state is described below. FIG. 16 through FIG. 18 illustrate the flow of the signals in the directional coupler.

An even mode is created in the electromagnetic coupled state, and an odd mode is created in the capacitively coupled state. As illustrated in FIG. 16, in the even mode, electromagnetic induction in the electromagnetic coupled state causes a signal Sig 2 to flow along the sub-line in the direction opposite to the direction of a signal Sig 1 flowing along the main line. As illustrated in FIG. 17 on the other hand, in the odd mode, an electric field caused generated by the capacitive coupling causes a signal Sig 3 to flow in the opposite direction to the direction of the signal Sig 1 along the sub-line and a signal Sig 4 to flow in the same direction as the direction of the signal Sig 1 along the sub-line. As described above, the main line and the sub-line are electromagnetically coupled while also being capacitively coupled. As a result, part of the signal Sig 2 cancels out the signal Sig 4 as illustrated in FIG. 18. A signal Sig 5 generated when the part of the signal Sig 2 cancels out the signal Sig 4 flows along the sub-line in the opposite direction to the direction of the signal Sig 1. The directional coupler is based on the assumption that no signal is output at a terminal of the sub-line to which the signal Sig 4 flows and that a signal is output at a terminal of the sub-line to which the signals Sig 3 and Sig 5 flow. The characteristics that the sub-line of the directional coupler outputs a signal at only one of the two terminals thereof is referred to as directivity of the directional coupler. The directivity may be adjusted by adjusting the degree of electromagnetic coupling and capacitive coupling.

The directional coupler disclosed in Japanese Unexamined Patent Application Publication No. 2013-5076 includes the main line and the sub-line with the planes thereof opposed to each other and has a high degree of capacitive coupling. As a result, the odd mode appears stronger than the even mode in the directional coupler. Since the signals Sig 3 and Sig 4 flow in opposite directions in the odd mode, a desired directivity is difficult to achieve if the odd mode appears stronger than the even mode. The directional coupler disclosed in Japanese Unexamined Patent Application Publication No. 2013-5076 thus suffers from an insufficient directivity.

### BRIEF SUMMARY OF THE INVENTION

Accordingly, it is an object of the present invention to provide a directional coupler having a sufficient directivity.

According to preferred embodiments of the present invention, a directional coupler for use in a predetermined frequency band includes a laminate body including a laminate of a plurality of insulation layers, a first terminal through a fourth terminal disposed on a surface of the laminate body, a main line connected between the first terminal and the second terminal and disposed on the insulation layer, a first sub-line connected to the third terminal, electromagnetically coupled with the main line, and disposed on the insulation layer, a second sub-line connected to the fourth terminal, electromagnetically coupled with the main line, and disposed on the second sub-line, and a phase adjusting circuit connected between the first sub-line and the second sub-line and configured to cause a phase shift on a passing signal. The main line, the first sub-line and the second sub-line do not overlap each other in a plan view from a direction of lamination.

The embodiments of the present embodiment may provide a directional coupler with an improved directivity.

Other features, elements, characteristics and advantages of the present invention will become more apparent from the following detailed description of preferred embodiments of the present invention with reference to the attached drawings.

### BRIEF DESCRIPTION OF THE SEVERAL VIEWS OF THE DRAWINGS

FIG. 1 is an equivalent circuit diagram of directional couplers according to first through fourth embodiments of the present invention;

FIG. 2 is an external perspective view of the directional couplers according to the first through fourth embodiments of the present invention;

FIG. 3A is an exploded perspective view of a laminate body of the directional coupler according to the first embodiment;

FIG. 3B shows the line portions of the laminate body in FIG. 3A stacked together;

FIG. 4 is an exploded perspective view of the laminate body of a directional coupler according to a modified embodiment of the present invention;

FIG. 5 is a graph representing transmission characteristics of a first sample;

FIG. 6 is a graph representing coupling characteristics and isolation characteristics of the first sample;

FIG. 7 is a graph representing transmission characteristics of a second sample;

FIG. 8 is a graph representing coupling characteristics and isolation characteristics of the second sample;

FIG. 9 is a graph representing simulation results of a first model;

FIG. 10 is a graph representing simulation results of a second model;

FIG. 11 is a graph representing simulation results of a third model;

FIG. 12 is a graph representing simulation results of a fourth model;

FIG. 13 is a graph representing simulation results of a fifth model;

FIG. 14 is an exploded perspective view of a laminate body of the directional coupler according to the second embodiment of the present invention;

FIG. 15 is an exploded perspective view of the laminate body of the directional coupler according to a modified embodiment of the present invention;

FIG. 16 illustrates the flow of a signal in the directional coupler;

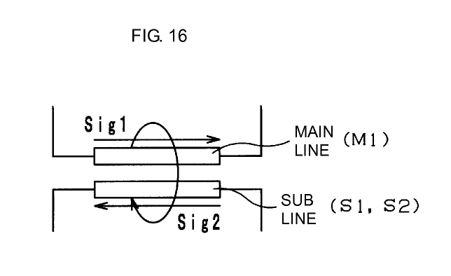

FIG. 17 illustrates the flow of a signal in the directional coupler; and

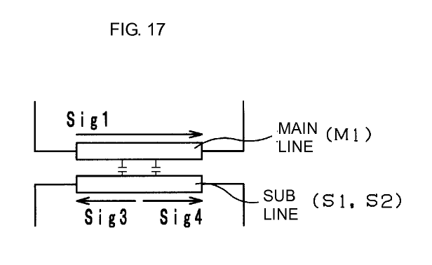

FIG. 18 illustrates the flow of a signal in the directional coupler.

### DETAILED DESCRIPTION OF THE PREFERRED EMBODIMENTS

Directional couplers according to embodiments of the present invention are described below.

### First Embodiment

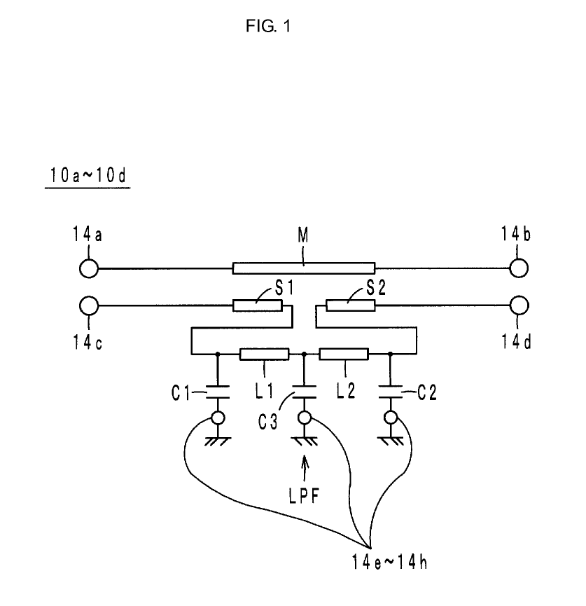

A directional coupler of a first embodiment is described below with reference to the drawings. FIG. 1 is an equivalent circuit diagram of directional couplers 10a through 10d according to first through fourth embodiments.

The circuit of the directional coupler 10a is described below. The directional coupler 10a is used in a predetermined frequency band. For example, the predetermined frequency band is 824 MHz through 1910 MHZ if the directional coupler 10a receives a signal having a frequency bandwidth of 824 MHz through 915 MHZ (GSM800/900) and a signal having a frequency bandwidth of 1710 MHZ through 1910 MHz (GSM1800/1900).

The directional coupler 10a includes, as circuit elements, external electrodes (terminals) 14a through 14h, a main line M, sub-lines S1 and S2, and a low-pass filter LPF. The main line M is connected between the external electrodes 14a and 14b. The sub-line S1 is connected to the external electrode 14c, and is electromagnetically coupled with the main line M. The sub-line S2 is connected to the external electrode 14d, and is electromagnetically coupled with the main line M. The sub-line S1 and the sub-line S2 have the same line length.

The low-pass filter LPF is a phase adjusting circuit that is connected between the sub-line S1 and the sub-line S2. The low-pass filter causes in a passing signal a phase shift having an absolute value that increases monotonously within a range of about 0 degree or higher to about 180 degrees or lower as the passing signal is higher in frequency in the predetermined frequency band. The cutoff frequency of the low-pass filter LPF is not within the predetermined frequency band. In the first embodiment, the cutoff frequency of the low-pass filter LPF is spaced away from a predetermined frequency by 1 GHz or more. The low-pass filter LPF includes coils L1 and L2, and capacitors C1 through C3.

The coils L1 and L2 are connected in series between the sub-lines S1 and S2 and are not electromagnetically coupled with the main line M. The coil L1 is connected to the sub-line S1, and the coil L2 is connected to the sub-line S2.

The capacitor C1 is connected to one end of the coil L1. More specifically, the capacitor C1 is connected between the junction of the coil L1 and the sub-line S1, and external electrodes 14e through 14h. The capacitor C2 is connected to one end of the coil L2. The capacitor C2 is connected between the junction of the coil L2 and the sub-line S2, and the external electrodes 14e through 14h. The capacitor C3 is connected between the junction of the coil L1 and the coil L2 and the external electrodes 14e through 14h.

In the directional coupler 10a thus constructed, the external electrode 14a serves as an input port and the external electrode 14b serves as an output port. The external electrode 14c serves as a coupling port and the external electrode 14d serves as a termination port that is terminated with 50Ω. The external electrodes 14e through 14h serve as ground ports that are to be grounded. A signal, input to the external electrode 14a, is output from the external electrode 14b. Since the main line M is electromagnetically coupled with the sub-lines S1 and S2, a signal having power proportional to power of the signal output from the external electrode 14b is output from the external electrode 14c.

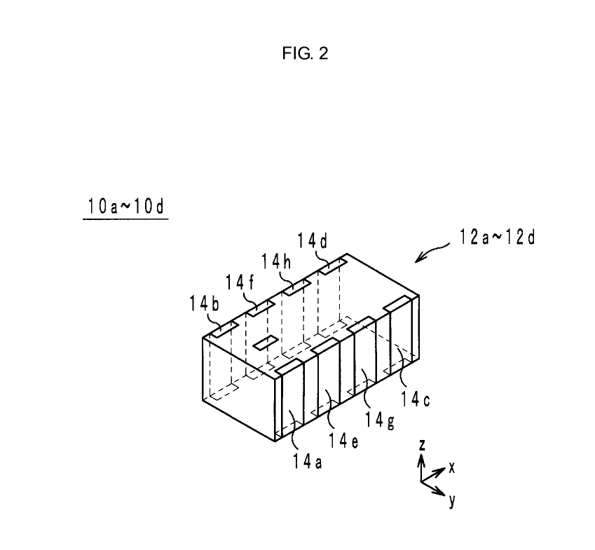

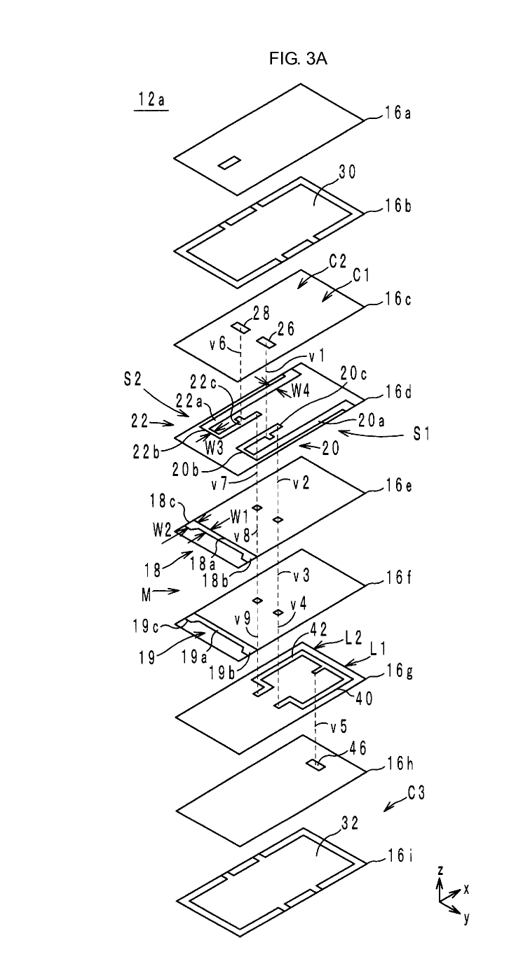

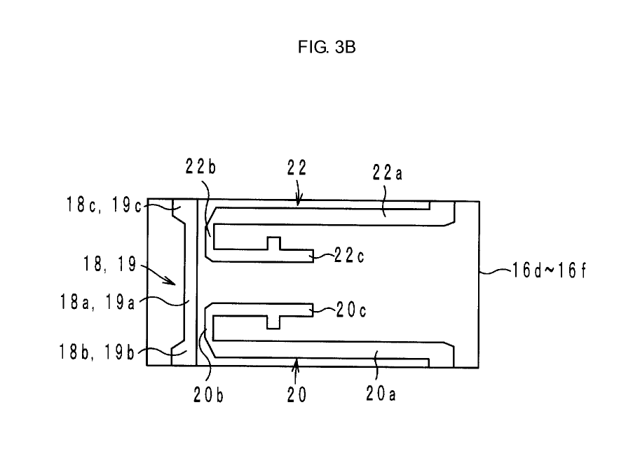

The structure of the directional coupler 10a is specifically described with reference to the drawings. FIG. 2 is an external perspective view of the directional couplers 10a through 10d of the first through fourth embodiments of the present invention. FIG. 3A is an exploded perspective view of a laminate body 12a of the directional coupler 10a of the first embodiment. FIG. 3B illustrates line portions 18, 19, 20, and 22 in the laminated state thereof. In the discussion that follows, a z-axis direction is defined as the direction of lamination, an x-axis direction is defined as the direction along the long side of the directional coupler 10a in a plan view from the z-axis direction, and a y-axis direction is defined as the direction along the short side of the directional coupler 10a in a plan view from the z-axis direction. The x axis, the y axis and the z axis are mutually perpendicular to each other.

As illustrated in FIG. 2 and FIG. 3A, the directional coupler 10a includes the laminate body 12a, the external electrodes 14a through 14h, the main line M, the sub-lines S1 and S2, the low-pass filter LPF, and via hole conductors v1 through v9. As illustrated in FIG. 2, the laminate body 12a is a rectangular parallelepiped. As illustrated in FIG. 3A, the laminate body 12a is constructed by laminating insulation layers 16a through 16i successively along the z axis from a positive direction to a negative direction of the z axis. The plane of the laminate body 12a in the negative direction of the z axis is a mounting surface that is engaged with a circuit board when the directional coupler 10a is mounted on the circuit board. The insulation layers 16a through 16i are manufactured of dielectric ceramic, and are rectangular in shape.

The external electrodes 14a, 14e, 14g, and 14c are disposed on the side surface of the laminate body 12a on the positive side in the y axis direction in that order from the negative side to the positive side in the x axis direction. The external electrodes 14b, 14f, 14h, and 14d are disposed on the side surface of the laminate body 12a on the negative side in the y axis direction in that order from the negative side to the positive side in the x axis direction.

The main line M includes line portions 18 and 19 as illustrated in FIG. 3A. The line portions 18 and 19 are linear conductor layers and are disposed on different insulation layers 16e and 16f near short sides of the insulation layers 16e and 16f on the negative side of the x axis direction and extend in the y axis direction. The line portions 18 and 19 are symmetrical with respect to a center line of the insulation layers 16e and 16f passing at the center of the y axis direction and extending along the x axis direction. The line portions 18 and 19 are identical in shape, and are laminated in alignment in a plan view from the z axis direction.

The line portion 18 includes segments 18a through 18c. The segment 18b is an end portion of the line portion 18 on the positive side of the y axis direction and the segment 18c is an end portion of the line portion 18 on the negative side of the y axis direction. The segment 18a is a portion between the segments 18b and 18c. The line portion 19 includes segments 19a through 19c. The segment 19b is an end portion of the line portion 19 on the positive side of the y axis direction and the segment 19c is an end portion of the line portion 19 on the negative side of the y axis direction. The segment 19a is a portion between the segments 19b and 19c.

The end portions on the positive side of the y axis direction as the segments 18b and 19b are connected to the external electrode 14a, and the end portions on the negative side of the y axis direction as the segments 18c and 19c are connected to the external electrode 14b. The line portions 18 and 19 are thus connected in parallel between the external electrodes 14a and 14b. In this way, the main line M linearly directly connects the external electrode 14a to the external electrode 14b.

As illustrated in FIG. 3A, the sub-line S1 includes a line portion 20, and is a letter U-shaped conductor disposed on the insulation layer 16d as illustrated in FIG. 3A. More in detail, the line portion 20 includes segments 20a through 20c. The segment 20a extends in the x axis direction along the long side of the insulation layer 16d on the positive side of the y axis direction. The end portion of the segment 20a on the positive side of the x axis direction is connected to the external electrode 14c. As illustrated in FIG. 3B, the segment 20b, in a plan view from the z axis direction, extends in the y axis direction so that the segment 20b runs in parallel with the segments 18a and 19a of the line portions 18 and 19 along the positive side of the y axis direction from the center of the y axis direction. In this way, the sub-line S1 is electromagnetically coupled with the main line M. However, the main line M and the sub-line S1 have no overlap portion therebetween in a plan view from the z axis direction. The end portion of the segment 20b on the positive side of the y axis direction is connected to the end portion of the segment 20a on the positive side of the x axis direction. The end portion of the segment 20b the on the positive side of the y axis direction (in other words, the end portion of the segment 20b closer to the external electrode 14a) is located more negative side of the y axis direction (in other words, spaced more apart from the outline of the insulation layers 16d through 16f) than the end portions of the segments 18a and 19a on the positive side of the y axis direction (in other words, the end portions closer to the external electrode 14a). The segment 20c is disposed on more negative side of the y axis direction than the segment 20a and extends in the x axis direction. The end portion of the segment 20c on the negative side of the x axis direction is connected to the end portion of the segment 20b on the negative side of the y axis direction.

The sub-line S2 includes a line portion 22, and is a letter U-shaped conductor disposed on the insulation layer 16d as illustrated in FIG. 3A. The sub-line S2 is symmetrical with the sub-line S1 with respect to a line, passing in perpendicular to the y axis direction through the center of the insulation layer 16d. More in detail, the line portion 22 includes segments 22a through 22c. The segment 22a extends in the x axis direction along the long side of the insulation layer 16d on the negative side of the y axis direction. The end portion of the segment 22a on the positive side of the x axis direction is connected to the external electrode 14d. As illustrated in FIG. 3B, the segment 22b, in a plan view from the z axis direction, extends in the y axis direction so that the segment 22b runs in parallel with the segments 18a and 19a of the line portions 18 and 19 along the negative side of the y axis direction from the center of the y axis direction. In this way, the sub-line S2 is electromagnetically coupled with the main line M. However, the main line M and the sub-line S2 have no overlap portion therebetween in a plan view from the z axis direction. The end portion of the segment 22b on the negative side of the y axis direction is connected to the end portion of the segment 22a on the positive side of the x axis direction. The end portion of the segment 22b on the negative side of the y axis direction (in other words, the end portion of the segment 22b closer to the external electrode 14b) is located more positive side of the y axis direction (in other words, spaced more apart from the outline of the insulation layers 16d through 16f) than the end portions of the segments 18a and 19a on the negative side of the y axis direction (in other words, the end portions closer to the external electrode 14b). The segment 22c is disposed on more positive side of the y axis direction than the segment 22a and extends in the x axis direction. The end portion of the segment 22c on the negative side of the x axis direction is connected to the end portion of the segment 22b on the positive side of the y axis direction.

A line width W1 of the segments 18a and 19a of the main line M running in parallel with the sub-lines S1 and S2 is larger than a line width W3 of the segments 20b and 22b of the sub-lines S1 and S2 running in parallel with the main line M. A line width W2 of the segments 18b, 18c, 19b, and 19c of the main line M running in non-parallel with the sub-lines S1 and S2 is larger than the line width W1 of the segments 18a and 19a of the main line M running in parallel with the sub-lines S1 and S2. A line width W4 of the segments 20a, 20c, 22a, and 22c of the sub-lines S1 and S2 running in non-parallel with the main line M is larger than the line width W3 of the segments 20b and 22b of the sub-lines S1 and S2 running in parallel with the main line M. Increasing the line width reduces a direct current resistance, leading to a decrease in the loss of the main line M and the sub-lines S1 and S2.

The low-pass filter LPF includes the coils L1 and L2 and the capacitors C1 through C3. The coils L1 and L2 and the capacitors C1 through C3 are manufactured of conductive layers disposed on an insulation layer different from the insulation layer 16d supporting the sub-lines S1 and S2. More specifically, the coil L1 includes a line portion 40. The line portion 40 is disposed on the insulation layer 16g, and is a line conductive layer half-circularly counterclockwise extending in a plan view from the z axis direction. In the following discussion, an end portion of an upstream side of the line portion 40 in the counterclockwise extension is referred to as an upstream end, and an end portion of a downstream side of the line portion 40 in the counterclockwise extension is referred to as a downstream end. The upstream end of the line portion 40 overlaps the end portion of the segment 20c on the positive side of the x axis direction in a plan view from the z axis direction.

The via hole conductors v2 through v4 respectively penetrate the insulation layers 16d through 16f in the z axis direction, and are connected to each other, thereby functioning as a single via hole conductor. The via hole conductor v2 is connected to the end portion of the segment 20c on the positive side of the x axis direction. The via hole conductor v4 is connected to the upstream end of the line portion 40.

The coil L2 includes a line portion 42. The line portion 42 is disposed on the insulation layer 16g, and is a line conductive layer half-circularly clockwise extending in a plan view from the z axis direction. In the following discussion, an end portion of an upstream side of the line portion 42 in the clockwise extension is referred to as an upstream end, and an end portion of a downstream side of the line portion 42 in the clockwise extension is referred to as a downstream end. The downstream end of the line portion 40 and the downstream end of the line portion 42 are connected together. The upstream end of the line portion 42 overlaps the end portion of the segment 22c on the positive side of the x axis direction in a plan view from the z axis direction.

Via hole conductors v7 through v9 respectively penetrate the insulation layers 16d through 16f in the z axis direction, and are connected to each other, thereby functioning as a single via hole conductor. The via hole conductor v7 is connected to the end portion of the segment 22c on the positive side of the x axis direction. The via hole conductor v9 is connected to the upstream end of the line portion 42.

The capacitor C1 includes a capacitor conductor 26 and a ground conductor 30. The capacitor conductor 26 having a rectangular shape is disposed on the insulation layer 16c. The capacitor conductor 26 overlaps an area of the segment 20c close to the end portion the segment 20c on the positive side of the x axis direction in a plan view from the z axis direction. The ground conductor 30 is disposed on the insulation layer 16b, and generally covers the surface of the insulation layer 16b. The ground conductor 30 is opposed to the capacitor conductor 26 with the insulation layer 16b interposed therebetween. In this way, a capacitor is created between the capacitor conductor 26 and the ground conductor 30. The ground conductor 30 is connected to the external electrodes 14e through 14h.

The via hole conductor v1 penetrates the insulation layer 16c in the z axis direction and connects the capacitor conductor 26 to the area of the segment 20c close to the end portion of the segment 20c on the positive side of the x axis direction. In this way, the capacitor C1 is connected between the end portion of the sub-line S1 and the external electrodes 14e through 14h.

The capacitor C2 includes a capacitor conductor 28 and the ground conductor 30. The capacitor conductor 28 having a rectangular shape is disposed on the insulation layer 16c. The capacitor conductor 28 overlaps an area of the segment 22c close to the end portion of the segment 22c on the positive side of the x axis direction in a plan view from the z axis direction. The ground conductor 30 is disposed on the insulation layer 16b, and generally covers the surface of the insulation layer 16b. The ground conductor 30 is opposed to the capacitor conductor 28 with the insulation layer 16b interposed therebetween. In this way, a capacitor is created between the capacitor conductor 28 and the ground conductor 30.

The via hole conductor v6 penetrates the insulation layer 16c in the z axis direction and connects the capacitor conductor 28 to the area of the segment 22c close to the end portion of the segment 22c on the positive side of the x axis direction. In this way, the capacitor C2 is connected between the end portion of the sub-line S2 and the external electrodes 14e through 14h.

The capacitor C3 includes a capacitor conductor 46 and a ground conductor 32. The capacitor conductor 46 having a rectangular shape is disposed on the insulation layer 16h. The capacitor conductor 46 overlaps the downstream ends of the line portions 40 and 42 in a plan view from the z axis direction. The ground conductor 32 is disposed on the insulation layer 16i, and generally covers the surface of the insulation layer 16i. The ground conductor 32 is opposed to the capacitor conductor 46 with the insulation layer 16h interposed therebetween. In this way, a capacitor is created between the capacitor conductor 46 and the ground conductor 32. The ground conductor 32 is connected to the external electrodes 14e through 14h.

The via hole conductor v5 penetrates the insulation layer 16g in the z axis direction and connects the capacitor conductor 46 to the downstream end of the line portions 40 and 42. In this way, the capacitor C3 is connected between the junction of the coil L1 and the coil L2 and the external electrodes 14e through 14h.

The directional coupler 10a of the present embodiment provides an excellent directivity. More specifically, the directional coupler disclosed in Japanese Unexamined Patent Application Publication No. 2013-5076 includes the main line and the sub-line with the planes thereof opposed to each other, and has a stronger capacitive coupling. As a result, the odd mode appears stronger than the even mode on the directional coupler. Since the signals Sig 3 and Sig 4 travel in mutually opposite directions, the odd mode stronger than the even mode makes it difficult to achieve a desired directivity.

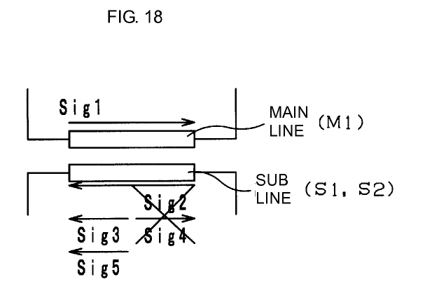

The directional coupler 10a includes the main line M and the sub-lines S1 and S2 which do not overlap each other in a plan view from the z axis direction. The directional coupler 10a thus restricts the generation of the odd mode in contrast with the directional coupler disclosed in Japanese Unexamined Patent Application Publication No. 2013-5076. As illustrated in FIG. 18, part of the signal Sig 2 and the signal Sig 4 cancel each other in the sub-lines S1 and S2. As a result, the signal Sig 1 flows in the direction opposite to the direction of the signal Sig 5 in the sub-lines S1 and S2. In the directional coupler 10a, no signal is output from the external electrode 14d but a signal is output from the external electrode 14c. The directional coupler 10a thus provides an excellent directivity.

The main line M and the sub-lines S1 and S2 are disposed on the different insulation layers in the directional coupler 10a. This arrangement allows the insulation layer 16d to be interposed between the main line M and the sub-lines S1 and S2. A voltage created between the main line M and the sub-lines S1 and S2 controls the generation of ion migration.

The directional coupler 10a also provides improved transmission characteristics. The transmission characteristics are a ratio of the intensity value of a signal output from the external electrode 14b to the intensity value of a signal input to the external electrode 14a. The main line M and the sub-lines S1 and S2 do not overlap each other in a plan view from the z axis direction in the directional coupler 10a. For this reason, even if the line width of the main line M is increased, there is almost no increase in the capacitance formed between the main line M and the sub-lines S1 and S2. The directivity of the directional coupler 10a is not degraded in large amount. The increase in the line width of the main line M reduces a direct current resistance value of the main line M. As a result, the transmission characteristics of the directional coupler 10a are thus improved.

The main line M includes the line portions 18 and 19 connected in parallel in the directional coupler 10a. This arrangement reduces the direct current resistance value of the main line M. As a result, the transmission characteristics of the directional coupler 10a are improved further.

In the directional coupler 10a, the main line M has a line-symmetric structure, and also the sub-lines S1 and S2 are line-symmetric with each other. This arrangement provides the same characteristics regardless of whether the directional coupler 10a operates with the external electrode 14b serving as an input port, the external electrode 14a serving as an output port, the external electrode 14d serving as a coupling port, and the external electrode 14c serving as a termination port, or the directional coupler 10a operates with the external electrode 14a serving as an input port, the external electrode 14b serving as an output port, the external electrode 14c serving as a coupling port, and the external electrode 14d serving as a termination port.

The end portion of the segment 20b on the positive side of the y axis direction is located on more negative side in the y axis direction than the end portions of the segments 18a and 19a on the positive side of the y axis direction. This arrangement allows the segments 18b and 19b of the line portions 18 and 19 not contributing to the coupling with the line portion 20 to be shorter. Similarly, the end portion of the segment 22b on the negative side of the y axis direction is located on more positive side of the y axis direction than the end portions of the segments 18a and 19a on the negative side of the y axis direction. This arrangement allows the segments 18c and 19c of the line portions 18 and 19 not contributing to the coupling with the line portion 22 to be shorter. The segments 18a, 18b, 19a, and 19b of the line portions 18 and 19 not contributing to the coupling with the line portions 20 and 22 are shortened, and direct current resistance is reduced. The direct current resistance values of the segments 18a, 18b, 19a, and 19b are reduced. Note that the segments 18a, 18b, 19a, and 19b are shortened while the segments 20a and 22b are lengthened. The sub-lines S1 and S2 have a higher priority on coupling than on resistance value. An increase in the direct current resistance value of the line portions 20 and 22 caused by the lengthened segments 20 and 22 is not problematic.

As described below, the directional coupler 10a has amplitude characteristics of a coupling signal close to a flat pattern. More specifically, the directional coupler 10a includes the low-pass filter LPF between the sub-line S1 and the sub-line S2. The low-pass filter LPF includes a coil, and a capacitor or a transmission line. The low-pass filter LPF thus causes on a signal passing therethrough (passing signal) a phase shift having an absolute value that monotonously increases within a range of from about 0 degrees or higher to about 180 degrees or lower as the passing frequency increases within a predetermined frequency band. The directional coupler 10a thus has the amplitude characteristics of the signal output from the coupling port (the external electrode 14c) close to a flat pattern.

### Modifications

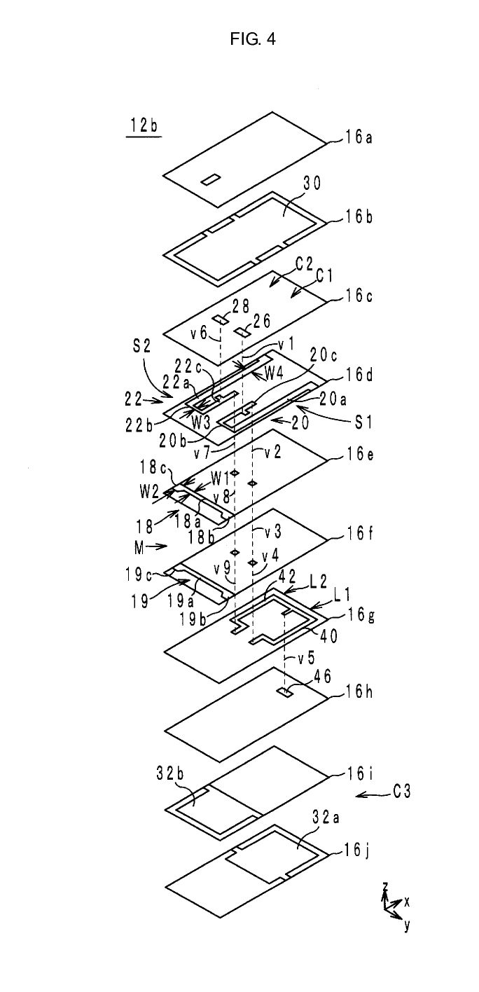

A directional coupler 10b as a modification is described below with reference to the drawings. FIG. 4 illustrates a laminate body 12b of the directional coupler 10b of the modification. Refer to FIG. 2 for the external perspective view of the directional coupler 10b.

The directional coupler 10b is different from the directional coupler 10a in that the ground conductor 32 is divided into ground conductors 32a and 32b. The following discussion of the directional coupler 10b focuses on this difference.

The laminate body 12b is constructed by laminating insulation layers 16a through 16j successively in the z axis from a positive direction to a negative direction of the z axis direction. The ground conductor 32a covers about half of the top surface of the insulation layer 16j on the positive side of the x axis direction. The ground conductor 32a is opposed to the capacitor conductor 46, thereby forming the capacitor C3. The ground conductor 32a is opposed to the line portions 40 and 42 as the coils L1 and L2.

The ground conductor 32b is disposed on the insulation layer 16i different from the insulation layer 16j supporting the ground conductor 32a. The ground conductor 32b covers about half of the top surface of the insulation layer 16i on the negative side of the x axis direction. The ground conductor 32b is opposed to the line portion 19 as the main line M.

In the directional coupler 10b thus constructed, the ground conductor 32a opposed to the line portions 40 and 42 and the ground conductor 32b opposed to the line portion 19 are disposed different insulation layers, namely, the insulation layer 16i and the insulation layer 16j. This arrangement allows the spacing between the line portions 40 and 42 and the ground conductor 32a and the spacing between the line portion 19 and the ground conductor 32b to be adjusted independently. The capacitance formed between the line portions 40 and 42 and the ground conductor 32a and the capacitance formed between the line portion 19 and the ground conductor 32b may be adjusted independently. As a result, the characteristic impedance of the main line M and the characteristic impedance of the sub-lines S1 and S2 may be independently adjusted.

The inventor of this invention conducted the following test to clarify the advantageous effects of the directional couplers 10a and 10b.

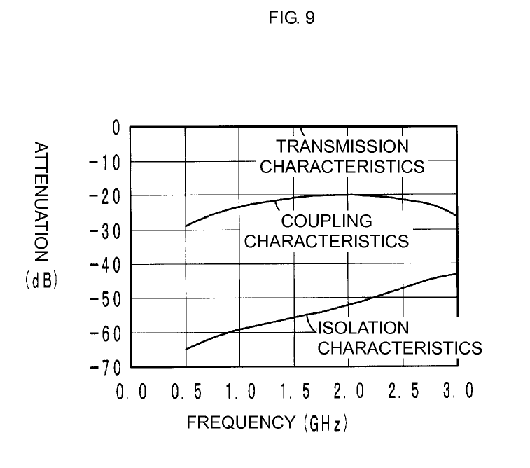

The inventor manufactured as a first sample the directional coupler 10b having the structure of FIG. 4, and as a second sample the directional coupler having the structure of FIG. 9 disclosed in Japanese Unexamined Patent Application Publication No. 2013-5076. Specifications common to the first and second samples are listed below.

Size: 4.5 mm×3.2 mm×1.5 mm

Coupling characteristics in 2 GHz band: −20 dB

Isolation characteristics in 2 GHz band: −57 dB

Directivity in 2 GHz band: −37 dB

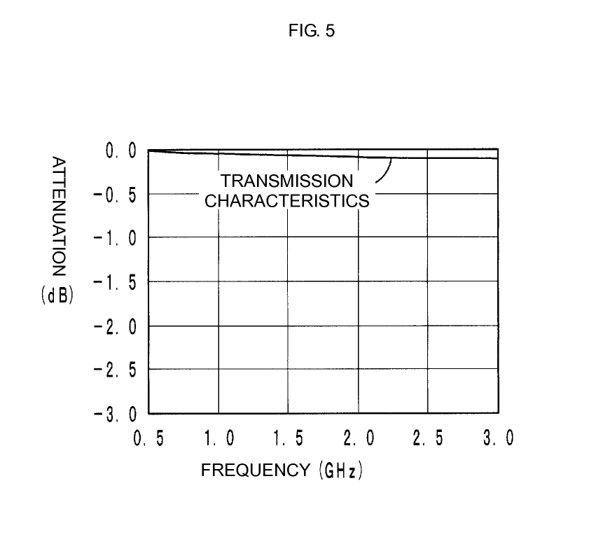

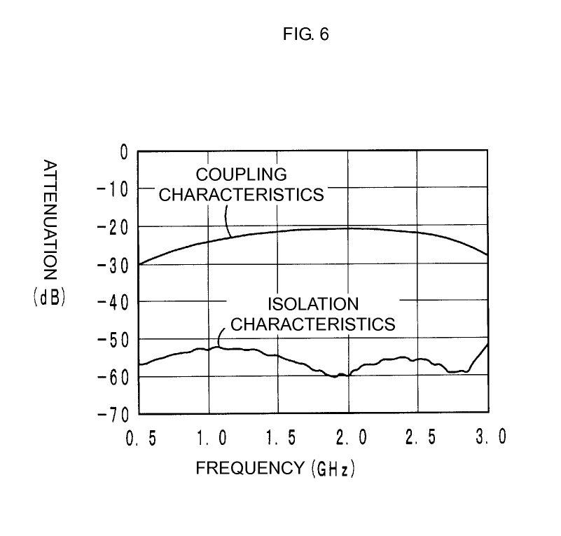

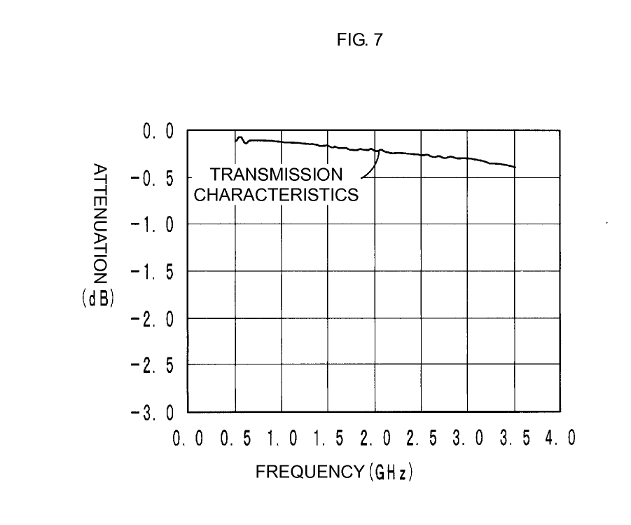

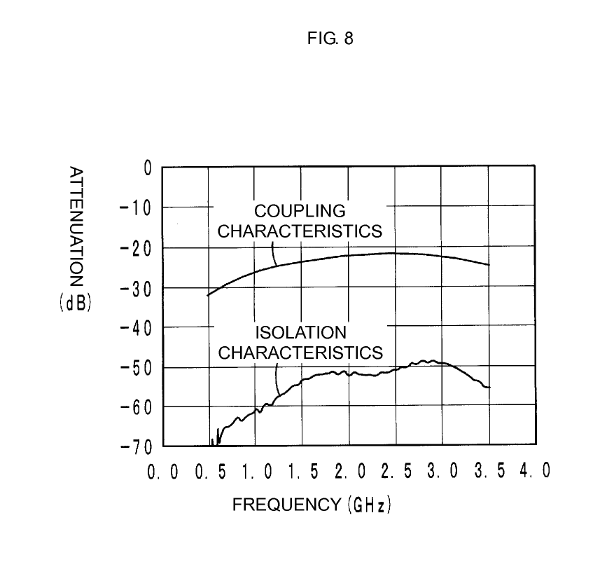

FIG. 5 is a graph illustrating transmission characteristics of the first sample. FIG. 6 is a graph illustrating coupling characteristics and isolation characteristics of the first sample. FIG. 7 is a graph illustrating transmission characteristics of the second sample. FIG. 8 is a graph illustrating coupling characteristics and isolation characteristics of the second sample. In each graph, the ordinate represents attenuation, and the abscissa represents frequency.

The transmission characteristics are a ratio of the intensity value of a signal output from the output port (the external electrode 14b) to the intensity value of a signal input to the input port (the external electrode 14a). The coupling characteristics are a ratio of the intensity value of a signal output from the coupling port (the external electrode 14c) to the intensity value of the signal input to the input port (the external electrode 14a). The isolation characteristics are a ratio of the intensity value of a signal output from the termination port (the external electrode 14d) to the intensity value of the signal input to the input port (the external electrode 14a).

Better transmission characteristics mean that attenuation is closer to 0 dB in the graphs of FIG. 5 and FIG. 7. Better coupling characteristics mean that attenuation is closer to 0 dB in the graphs of FIG. 6 and FIG. 8. Better isolation characteristics mean that attenuation is farther from 0 dB in the graphs of FIG. 6 and FIG. 8.

As illustrated in FIG. 8, the line width of the main line M and the like in the second sample is designed so that the coupling characteristics on 2 GHz approaches −20 dB. More specifically, the line width of the main line M is decreased in the second sample to reduce the capacitance formed between the main line M and the sub-lines S1 and S2. In the second sample, however, the direct current resistance value of the main line M increases, degrading the transmission characteristics as illustrated in FIG. 7.

Since the main line M and the sub-lines S1 and S2 are opposed to each other in the direction of lamination in the second sample, a relatively large capacitance is created between the main line and the sub-lines. For this reason, the second sample has a stronger odd mode, leading to a degraded directivity. The directivity refers to a ratio of the intensity of a signal output from the termination port to the intensity of a signal output from the coupling port. The degraded directivity means degraded coupling characteristics or degraded isolation characteristics. The second sample has degraded isolation characteristics as illustrated in FIG. 8.

The first sample designed to have the coupling characteristics as high as −20 dB on 2 GHz is better in the transmission characteristics than the second sample as illustrated in FIG. 5. According the test results, the first sample provides the better transmission characteristics than the second sample.

The first sample and second sample have the coupling characteristics as high as about −20 dB on 2 GHz. As illustrated in FIG. 6, however, the first sample provides the better isolation characteristics than the second sample. If the coupling characteristics and the transmission characteristics are better, the directivity is also better. According to the test results, the first sample is better in directivity than the second sample.

The inventor of the invention performed computer simulation to determine appropriate spacing between the segments 18a and 19a and the segments 20b and 22b in a plan view from the z axis direction. First through fifth models were created in the computer simulation.

### Specifications of the First Model

Structure of the first model: directional coupler 10b of FIG. 4

Line width of the segments 18a and 19a: 75 μm

Line width of the segments 22b and 22c: 50 μm

Spacing between the segments 18a and 19a and the segments 20b and 22b in a plan view from the z axis direction: 100 μm

Spacing between the segments 18a and 19a and the segments 20b and 22b in the z axis direction: 25 μm

Dielectric constant of the insulation layer: 6.8

### Specifications of the Second Model

Structure of the second model: directional coupler 10b of FIG. 4

Line width of the segments 18a and 19a: 75 μm

Line width of the segments 22b and 22c: 50 μm

Spacing between the segments 18a and 19a and the segments 20b and 22b in a plan view from the z axis direction: 150 μm

Spacing between the segments 18a and 19a and the segments 20b and 22b in the z axis direction: 25 μm

Dielectric constant of the insulation layer: 6.8

### Specifications of the Third Model

Structure of the third model: directional coupler 10b of FIG. 4

Line width of the segments 18a and 19a: 75 μm

Line width of the segments 22b and 22c: 50 μm

Spacing between the segments 18a and 19a and the segments 20b and 22b in a plan view from the z axis direction: 50 μm

Spacing between the segments 18a and 19a and the segments 20b and 22b in the z axis direction: 25 μm

Dielectric constant of the insulation layer: 6.8

### Specifications of the Fourth Model

Structure of the fourth model: directional coupler 10b of FIG. 4

Line width of the segments 18a and 19a: 75 μm

Line width of the segments 20b and 22b: 50 μm

Spacing between the segments 18a and 19a and the segments 20b and 22b in a plan view from the z axis direction: 50 μm

Spacing between the segments 18a and 19a and the segments 20b and 22b in the z axis direction: 100 μm

Dielectric constant of the insulation layer: 6.8

### Specifications of the Fifth Model

Structure of the fifth model: directional coupler 10b of FIG. 4 with the line portion 19 removed therefrom

Line width of the segments 18a and 19a: 75 μm

Line width of the segments 22b and 22c: 50 μm

Spacing between the segments 18a and 19a and the segments 20b and 22b in a plan view from the z axis direction: 100 μm

Spacing between the segments 18a and 19a and the segments 20b and 22b in the z axis direction: 25 μm

Dielectric constant of the insulation layer: 6.8

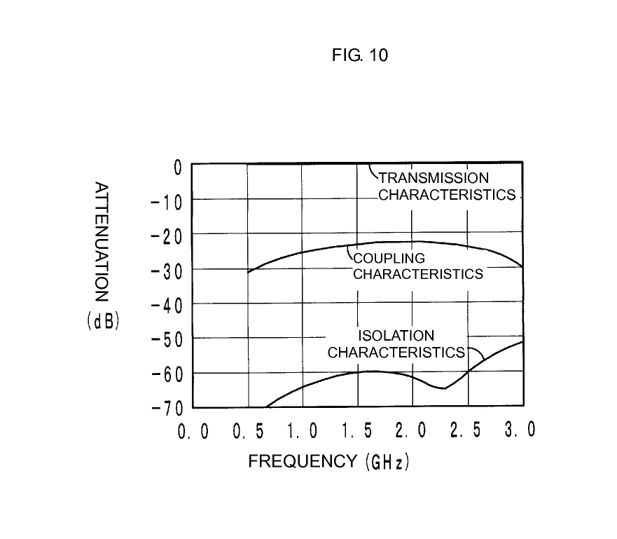

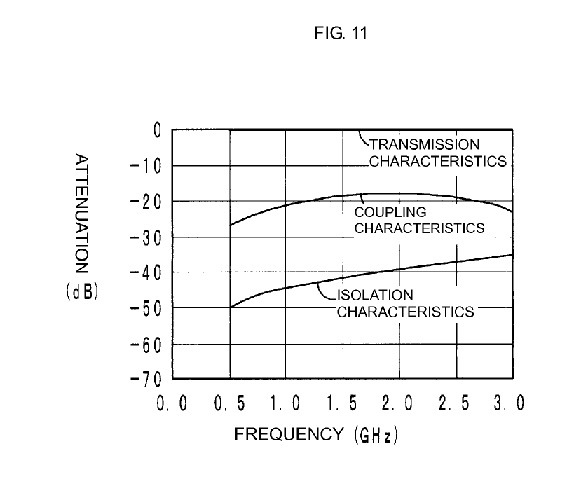

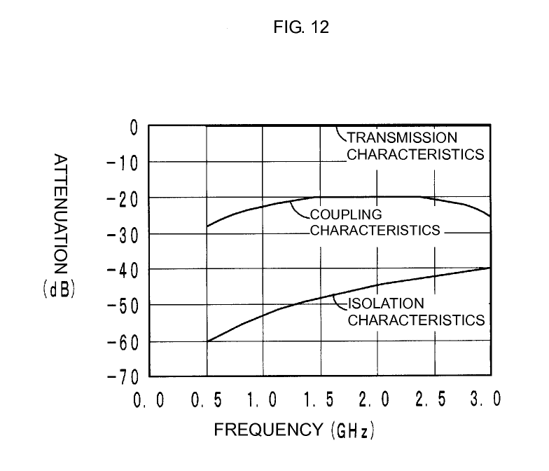

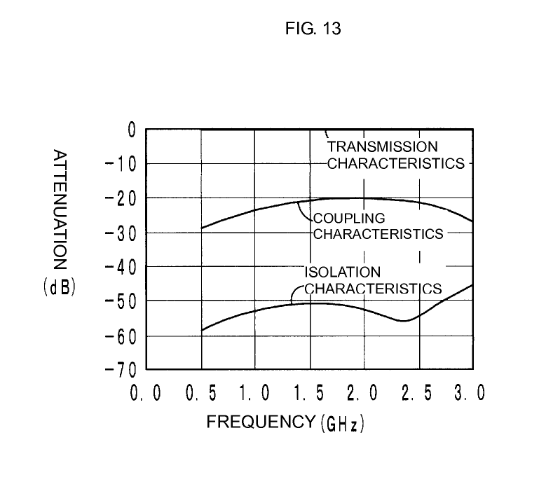

The transmission characteristics, the coupling characteristics, and the isolation characteristics are calculated using the first through fifth models. FIG. 9 is a graph illustrating the simulation results of the first model. FIG. 10 is a graph representing the simulation results of the second model. FIG. 11 is a graph representing the simulation results of the third model. FIG. 12 is a graph representing the simulation results of the fourth model. FIG. 13 is a graph representing the simulation results of the fifth model. In each graph, the ordinate represents attenuation, and the abscissa represents frequency.

By comparison of the simulation results of the first model with the simulation results of the second model with reference to FIG. 9 and FIG. 10, the first model has coupling characteristics of about −20 dB on 2 GHz while the second model has a larger attenuation value than −20 dB. As a result, the second model has smaller coupling characteristics. It is considered that the spacing between the segments 18a and 19a and the segments 20b and 22b in a plan view from the z axis direction is too large in the second model.

By comparison of the simulation results of the first model with the simulation results of the third model with reference to FIG. 9 and FIG. 11, the first model has coupling characteristics of about −20 dB on 2 GHz while the third model has a smaller attenuation value than −20 dB. As a result, the third model has larger coupling characteristics. It is considered that the spacing between the segments 18a and 19a and the segments 20b and 22b in a plan view from the z axis direction is too small in the third model. From the above results, the spacing between the segments 18a and 19a and the segments 20b and 22b in a plan view from the z axis direction is desirably as large as about 100 μm.

The simulation results of the fourth model are now studied. By comparison of the simulation results of the third model with the simulation results of the fourth model with reference to FIG. 11 and FIG. 12, the third model has isolation characteristics of about −39 dB on 2 GHz while the fourth model has isolation characteristics of about −45 dB on 2 GHz. The fourth model has a larger spacing between the segments 18a and 19a and the segments 20b and 22b in the z axis direction than the third model. However, since the fourth model, as the third model, has too small a spacing between the segments 18a and 19a and the segments 20b and 22b in a plan view from the z axis direction, a higher capacitance is created between the segments 18a and 19a and the segments 20b and 22b. For this reason, insufficient isolation characteristics result. If the spacing between the segments 18a and 19a and the segments 20b and 22b in a plan view from the z axis direction is too small, it is found difficult to achieve sufficient isolation characteristics even though the spacing between the segments 18a and 19a and the segments 20b and 22b is increased in the z axis direction.

The simulation results of the fifth model are now studied. Since the fifth model does not include the line portion 19, a direct current resistance value of the main line M is high. For this reason, the first model has transmission characteristics of −0.083 dB on 2 GHz while the fifth model has transmission characteristics of −0.093 dB on 2 GHz. This concludes that the line portion 18 and the line portion 19 are desirably connected in parallel.

### Second Embodiment

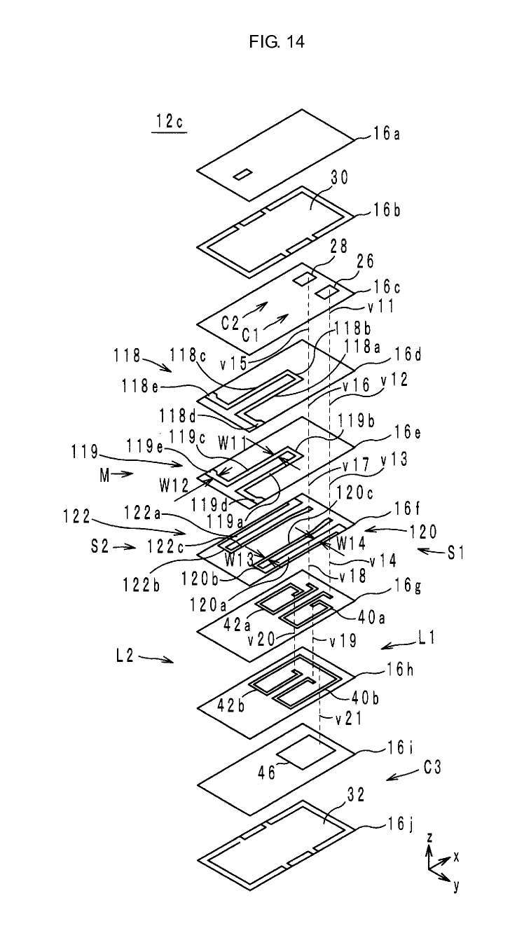

A specific structure of a directional coupler 10c of a second embodiment is described with reference to the drawings. FIG. 14 is an exploded perspective view of a laminate body 12c of the directional coupler 10c of the second embodiment. Reference is made to FIG. 2 for the external perspective view of the directional coupler 10c.

Referring to FIG. 2 and FIG. 14, the directional coupler 10c includes the laminate body 12c, external electrodes 14a through 14h, main line M, sub-lines S1 and S2, low-pass filter LPF, and via hole conductors vii through v18, and v21. The laminate body 12c and the external electrodes 14a through 14h in the directional coupler 10c are identical to the counterparts thereof in the directional coupler 10a, and the discussion thereof is omitted herein.

The main line M includes line portions 118 and 119 as illustrated in FIG. 14. The main line M has a line-symmetric structure with respect to a line passing in perpendicular to the y axis direction through the center of each of the insulation layers 16d and 16e in the x axis direction. The line portions 118 and 119 are disposed on different insulation layers 16d and 16e. The line portions 118 and 119 are identical in shape, and overlap in alignment in a plan view from the z axis direction.

The line portion 118 includes segments 118a through 118e. The segment 118d is an end portion of the line portion 118 on the positive side of the y axis direction, and the segment 118e is an end portion of the line portion 118 on the negative side of the y axis direction. The segments 118a through 118c are disposed between the segments 118d and 118e. The segment 118a is connected to an end portion of the segment 118d on the negative side of the y axis direction, and extends along the positive side of the x axis direction. The segment 118c is connected to an end portion of the segment 118e on the positive side of the y axis direction and extends along the positive side of the x axis direction. The segment 118b extends in the y axis direction and connects an end portion of the segment 118a on the positive side of the x axis direction to an end portion of the segment 118c on the positive portion of the x axis direction.

The line portion 119 includes the segments 119a through 119e. The segment 119d is an end portion of the line portion 119 on the positive side of the y axis direction, and the segment 119e is an end portion of the line portion 119 on the negative side of the y axis direction. The segments 119a through 119c are disposed between the segments 119d and 119e. The segment 119a is connected to an end portion of the segment 119d on the negative side of the y axis direction, and extends along the positive side of the x axis direction. The segment 119c is connected to an end portion of the segment 119e on the positive side of the y axis direction and extends along the positive side of the x axis direction. The segment 119b extends in the y axis direction and connects an end portion of the segment 119a on the positive side of the x axis direction to an end portion of the segment 119c on the positive portion of the x axis direction.

End portions of the segments 118d and 119d on the positive side on the y axis direction are connected to the external electrode 14a, and end portions of the segments 118e and 119e on the negative side of the y axis direction are connected to the external electrode 14b. The line portions 118 and 119 are thus connected in parallel between the external electrodes 14a and 14b.

The sub-line S1 includes a line portion 120, and is a letter U-shaped linear conductor disposed on the insulation layer 16f as illustrated in FIG. 14. More in detail, the line portion 120 includes segments 120a through 120c. The segment 120a extends in the x axis direction along the long side of the insulation layer 16f on the positive side of the y axis direction. The end portion of the segment 120a on the positive side of the x axis direction is connected to the external electrode 14c. The segment 120b is connected to an end portion of the segment 120a on the negative side of the x axis direction and extends in the negative direction of the y axis. The segment 120c is connected to an end portion of the segment 120b on the negative side of the y axis direction and extends in the x axis direction in parallel with the segments 118a and 119a of the line portion 118 and the line portion 119 in a plan view from the z axis direction. The sub-line S1 is thus electromagnetically coupled with the main line M. Note that the main line M and the sub-line S1 do not overlap each other in a plan view from the z axis direction.

The sub-line S2 includes a line portion 122, and is a letter U-shaped linear conductor disposed on the insulation layer 16f as illustrated in FIG. 14. More in detail, the line portion 122 includes segments 122a through 122c. The segment 122a extends in the x axis direction along the long side of the insulation layer 16f on the negative side of the y axis direction. The end portion of the segment 122a on the positive side of the x axis direction is connected to the external electrode 14d. The segment 122b is connected to an end portion of the segment 122a on the negative side of the x axis direction and extends in the positive direction of the y axis. The segment 122c is connected to an end portion of the segment 122b on the positive side of the y axis direction and extends in the x axis direction in parallel with the segments 118a and 119a of the line portion 118 and the line portion 119 in a plan view from the z axis direction. The sub-line S2 is thus electromagnetically coupled with the main line M. Note that the main line M and the sub-line S2 do not overlap each other in a plan view from the z axis direction.

A line width W11 of the segments 118a, 118c, 119a, and 119c of the main line M running in parallel with the sub-lines S1 and S2 is larger than a line width W13 of the segments 120c and 122c of the sub-lines S1 and S2 running in parallel with the main line M. A line width W12 of the segments 118b, 118d, 118e, 119b, 119d, and 119e of the main line M running in non-parallel with the sub-lines S1 and S2 is larger than the line width W11 of the segments 118a, 118c, 119a, and 119c of the main line M running in parallel with the sub-lines S1 and S2. A line width W14 of the segments 120a, 120b, 122a, and 122b of the sub-lines S1 and S2 running in non-parallel with the main line M is larger than the line width W13 of the segments 120c and 122c of the sub-lines S1 and S2 running in parallel with the main line M.

The low-pass filter LPF includes the coils L1 and L2 and the capacitors C1 through C3. The coils L1 and L2 and the capacitors C1 through C3 are manufactured of conductive layers disposed on insulation layers different from the insulation layer 16f supporting the sub-lines S1 and S2. More specifically, the coil L1 includes line portions 40a and 40b, and a via hole conductor v19. The line portion 40a is disposed on the insulation layer 16g, and is a line conductive layer almost circularly counterclockwise extending in a plan view from the z axis direction. In the following discussion, an end portion of an upstream side of the line portion 40a in the counterclockwise extension is referred to as an upstream end, and an end portion of a downstream side of the line portion 40a in the counterclockwise extension is referred to as a downstream end. The upstream end of the line portion 40a overlaps the end portion of the segment 120c on the positive side of the x axis direction in a plan view from the z axis direction.

The line portion 40b is disposed on the insulation layer 16h, and is a line conductive layer almost circularly counterclockwise extending in a plan view from the z axis direction. In the following discussion, an end portion of an upstream side of the line portion 40b in the counterclockwise extension is referred to as an upstream end, and an end portion of a downstream side of the line portion 40b in the counterclockwise extension is referred to as a downstream end. The upstream end of the line portion 40b overlaps the downstream end of the segment 40a in a plan view from the z axis direction.

The via hole conductor v19 connects the downstream end of the line portion 40a to the upstream end of the line portion 40b. A spiral coil L1 is thus formed.

The via hole conductor v14 penetrates the insulation layer 16f in the z axis direction, and connects the end portion of the segment 120c on the positive side of the x axis direction to the upstream end of the line portion 40a.

The coil L2 includes line portions 42a and 42b, and a via hole conductor v20. The line portion 42a is disposed on the insulation layer 16g, and is a line conductive layer almost circularly clockwise extending in a plan view from the z axis direction. In the following discussion, an end portion of an upstream side of the line portion 42a in the clockwise extension is referred to as an upstream end, and an end portion of a downstream side of the line portion 42a in the clockwise extension is referred to as a downstream end. The upstream end of the line portion 42a overlaps the end portion of the segment 122c on the positive side of the x axis direction in a plan view from the z axis direction.

The line portion 42b is disposed on the insulation layer 16h, and is a line conductive layer almost circularly clockwise extending in a plan view from the z axis direction. In the following discussion, an end portion of an upstream side of the line portion 42b in the clockwise extension is referred to as an upstream end, and an end portion of a downstream side of the line portion 42b in the clockwise extension is referred to as a downstream end. The upstream end of the line portion 42b overlaps the downstream end of the segment 42a in a plan view from the z axis direction.

The via hole conductor v20 connects the upstream end of the line portion 42a to the downstream end of the line portion 42b. A spiral coil L2 is thus formed.

The via hole conductor v18 penetrates the insulation layer 16f in the z axis direction, and connects the end portion of the segment 122c on the positive side of the x axis direction to the upstream end of the line portion 42a.

The capacitors C1 through C3 of the directional coupler 10c are identical in structure to the capacitors C1 through C3 in the directional coupler 10a, and the discussion thereof is omitted herein.

The line length where the main line M and the sub-lines S1 and S2 extend in parallel with each other in the directional coupler 10c is longer than the line length where the main line M and the sub-lines S1 and S2 extend in parallel with each other in the directional coupler 10a. The directional coupler 10c having a longer length where the main line M and the sub-lines S1 and S2 extend in parallel with each other works on a lower frequency band than the directional coupler 10a. For example, the directional coupler 10a is used on a frequency band in the vicinity of 2 GHz, while the directional coupler 10c is used on a frequency band in the vicinity of 1 GHz.

### Modifications

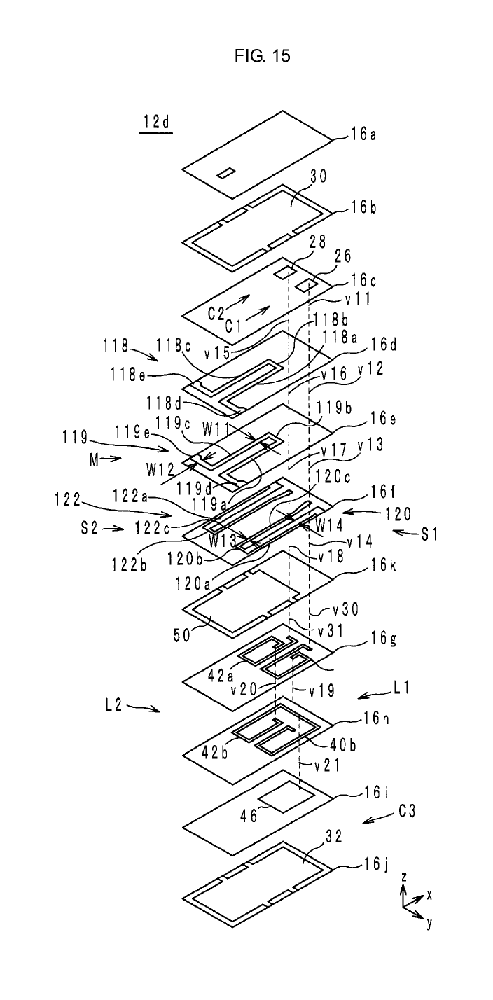

A directional coupler 10d as a modification is described below with reference to the drawings. FIG. 15 is an exploded perspective view of a laminate body 12d of the directional coupler 10d.

The directional coupler 10d is different from the directional coupler 10c in that the directional coupler 10d includes a ground conductor 50. The discussion of the directional coupler 10d focuses on the difference.

The directional coupler 10d includes an insulation layer 16k between the insulation layer 16f and the insulation layer 16g. The ground conductor 50 is disposed on the insulation layer 16k and overlaps line portions 118, 119, 120, 122, 40a, 40b, 42a, and 42b in a plan view from the z axis direction. More specifically, the ground conductor 50 is disposed between the coils L1 and L2 and the main line M and sub-lines S1 and S2 in the z axis direction. However, the ground conductor 50 does not cover an area along the short side of the insulation layer 16k on the positive side of the x axis direction in order to connect the line portion 120 to the line portion 40a and in order to connect the line portion 122 to the line portion 42a. The ground conductor 50 is connected to the external electrodes 14e through 14h.

As described above, the directional coupler 10d thus constructed includes the ground conductor 50 between the coils L1 and L2 and the main line M and sub-lines S1 and S2 in the z axis direction. This arrangement restricts the creation of capacitance between the coils L1 and L2 and the main line M and sub-lines S1 and S2 in the z axis direction, thereby controlling a variation from a desired value of the characteristic impedance of the main line M and the sub-lines S1 and S2.

### Other Modifications

The embodiments are not limited to the directional couplers 10a through 10d, and may be changed or modified with the scope of the present invention.

Not only the main line M but also the sub-lines S1 and S2 may include a plurality of line conductors connected in parallel. Since the characteristic impedance of the sub-lines S1 and S2 tends to vary, the sub-line desirably includes a smaller number of lines (more specifically, a smaller number of layers) than that of the main line M.

The structures of the directional couplers 10a through 10d may be combined.

The present invention is useful in the field of directional coupler, and is particularly advantageous in improving the directivity thereof.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A directional coupler for use in a predetermined frequency band, comprising:
a laminate body including a laminate of a plurality of insulation layers;
a first terminal through a fourth terminal disposed on a surface of the laminate body;
a main line connected between the first terminal and the second terminal and disposed on at least one of the insulation layers;
a first sub-line disposed on at least one of the insulation layers, connected to the third terminal, and electromagnetically coupled with the main line;
a second sub-line disposed on at least one of the insulation layers, connected to the fourth terminal, and electromagnetically coupled with the main line; and
a phase adjusting circuit connected between the first sub-line and the second sub-line and configured to cause a phase shift in a passing signal,
wherein the main line, the first sub-line and the second sub-line do not overlap each other in a plan view from a direction of lamination.

2. The directional coupler according to claim 1, wherein the phase adjusting circuit is a low-pass filter.

3. The directional coupler according to claim 2, wherein the main line is larger in line width than each of the first sub-line and the second sub-line.

4. The directional coupler according to claim 2, wherein the main line extends at least partially in parallel with the first sub-line and the second sub-line, and
wherein a segment of the main line that extends not in parallel with the first sub-line and the second sub-line is larger in line width than a segment of the main line that extends in parallel with the first sub-line and the second sub-line.

5. The directional coupler according to claim 2, wherein the main line extends at least partially in parallel with the first sub-line and the second sub-line, and
wherein a segment of the first sub-line or the second sub-line that extends not in parallel with the main line is larger in line width than a segment of the first sub-line or the second sub-line that extends in parallel with the main line.

6. The directional coupler according to claim 2, wherein the main line extends at least partially in parallel with the first sub-line, and
wherein the segment of the first sub-line extending in parallel with the main line has end portions, and one of the end portions closer to the third terminal is spaced more apart from an outer periphery of the insulation layer than one of end portions closer to the first terminal.

7. The directional coupler according to claim 2, wherein the low-pass filter comprises a conductive layer, and the conductive layer is disposed on at least one of the insulation layers different from at least one of the insulation layers on which the first sub-line is disposed and at least one of the insulation layers on which the second sub-line is disposed.

8. The directional coupler according to claim 2, wherein the main line comprises a plurality of conductive layers, and the plurality of conductive layers are connected in parallel to each other and disposed on different insulation layers among the plurality of insulation layers.

9. The directional coupler according to claim 2, wherein the main line linearly connects the first terminal to the second terminal.

10. The directional coupler according to claim 2, wherein the low-pass filter comprises:
a coil disposed on at least one of the insulation layers; and
a capacitor including a capacitor conductor connected to the coil, and a ground conductor that is opposed to the capacitor conductor and is disposed in the direction of lamination between the coil, and the main line, the first sub-line and the second sub-line.

11. The directional coupler according to claim 2, wherein the low-pass filter comprises:
a coil disposed on the insulation layer; and
a capacitor including a capacitor conductor connected to the coil, and a first ground conductor that is disposed on at least one of the insulation layers and is opposed to the capacitor conductor,
wherein the directional coupler further comprises a second ground conductor disposed on at least one of the insulation layers different from at least one of the insulation layer on which the first ground conductor is disposed.

12. The directional coupler according to claim 2, wherein the low-pass filter causes in the passing signal the phase shift having an absolute value that increases monotonously within a range of about 0 degree or higher to about 180 degrees or lower as a frequency of the passing signal increases in the predetermined frequency band.

13. The directional coupler according to claim 2, wherein the first terminal is an input terminal configured to receive a first signal,
wherein the second terminal is a first output terminal configured to output the first signal therefrom,
wherein the third terminal is a second output terminal configured to output a second signal having power proportional to power of the first signal, and
wherein the fourth terminal is a termination terminal.
